(19) United States
(12) Patent Application Publication
(10) Pub. No.: US 2007/0081103 A1
(43) Pub. Date: Apr. 12, 2007

(54) Display apparatus and control method thereof

(75) Inventors: Jae-hong Ahn, Seongnam-si (KR); Kil-soo Park, Suwon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/543,121

(22) Filed: Oct. 5, 2006

(30) Foreign Application Priority Data
Oct. 11, 2005 (KR) 10-2005-0095617
Feb. 16, 2006 (KR) 10-2006-0015092

(51) Int. Cl. G09G 5/02

(52) U.S. Cl. 348/655; 345/591

(57) ABSTRACT

A display apparatus includes a display unit; a signal processing unit which processes an image signal to be displayed on the display unit; a color transforming unit which adjusts a white balance of the image signal input from the signal processing unit within a color area defined by a set of adjacent colors in a color space; and a controlling unit which controls the color transforming unit to perform color-transformation on only a white color within the color area of colors of the image signal in order to adjust the white balance of the image signal.

### CROSS-REFERENCE TO RELATED APPLICATIONS

This application claims priority from Korean Patent Application No. 10-2005-0095617, filed on Oct. 11, 2005 and No. 10-2006-0015092, filed on Feb. 16, 2006, in the Korean Intellectual Property Office, the disclosures of which are incorporated herein by reference in its entirety.

### BACKGROUND OF THE INVENTION

1. Field of the Invention

The present invention relates to a display apparatus and a control method thereof, and more particularly, to a display apparatus with improved white balance of an image signal and a control method thereof.

2. Description of the Related Art

In general, display apparatuses, especially, color display apparatuses, are being widely used for equipments required to provide visual information to users, such as a television (TV), a digital TV (DTV), a thin film transistor (TFT) monitor or TV, a color printer, a digital camera, a projector, a mobile phone, etc.

In a display apparatus, display conditions of an image displayed on the display apparatus have been conventionally adjusted by processing attributes, such as hue, brightness, saturation and the like, of an image signal applied to the display apparatus. For example, white balance of the image displayed on the display apparatus may be adjusted by adjusting white color by combination of colors of the image signal applied to the display apparatus.

However, when the white balance is adjusted in such a conventional display apparatus, there arises a problem of change of hue and/or saturation of all colors of the image displayed on a display of the display apparatus. For example, if hue for blue color is increased to increase color temperature of white color of the image displayed on the display apparatus, color temperature of all colors of the image displayed on the display apparatus is changed. That is, even though a user tries to change only the color temperature of white color, there arises a problem of change of all colors.

### SUMMARY OF THE INVENTION

The present invention provides a display apparatus, which is capable of adjusting white balance of an image signal by changing only white color distributed in a color area, and a control method thereof.

According to an aspect of the present invention, there is provided a display apparatus comprising a display unit on which an image is displayed, comprising: a signal input unit to which an image signal is input; a signal processing unit for processing the image signal such that the image signal can be displayed on the display unit; a color transforming unit for adjusting white balance of the image signal input from the signal processing unit within a color area defined by a set of plurality of adjacent colors in a color space; and a controlling unit for controlling the color transforming unit to perform color-transformation on only a white color within the color area of colors of the image signal in order to adjust the white balance of the image signal.

According to an aspect of the present invention, the color transforming unit sets a color within the color area to be a reference color, and determines a degree of color-transformation of other colors within the color area based on a degree of color-transformation of the reference color.

According to an aspect of the present invention, the color space is a YCbCr color space.

According to an aspect of the present invention, the color area has an elliptical shape making an acute angle with coordinates of red and blue colors, with a color temperature axis as a major axis on the YCbCr color space.

According to an aspect of the present invention, when the white balance of the image signal is adjusted, the controlling unit transforms the reference color such that the reference color is adjacent to the coordinate of blue color within the color area in order to increase the color temperature of the white color, and transforms the reference color such that the reference color is adjacent to the coordinate of red color within the color area in order to decrease the color temperature of the white color.

According to an aspect of the present invention, the controlling unit receives a control signal to adjust the color temperature of the white color from an external apparatus and controls the color transforming unit to adjust the white balance according to the received control signal.

According to an aspect of the present invention, the controlling unit causes a pattern image to be displayed on the display unit and determines an adjustment condition of the white balance of the image signal adjusted in the color transforming unit according to change of the pattern image.

According to another aspect of the present invention, there is provided a control method of a display apparatus comprising a display unit on which an image is displayed, comprising: receiving an image signal; processing the image signal such that the image signal can be displayed on the display unit; and adjusting white balance of the processed image signal by adjusting a white color of the processed image signal within a color area defined by a set of plurality of adjacent colors in a color space.

According to an aspect of the present invention, the adjusting the white balance comprises: setting a color within the color area to be a reference color and determining a degree of color-transformation of other colors within the color area based on a degree of color-transformation of the reference color; and color-transforming a color within the color area depending on the determined degree of color-transformation.

According to an aspect of the present invention, the color space is a YCbCr color space.

According to an aspect of the present invention, the adjusting the white balance comprises: transforming the reference color such that the reference color is adjacent to the coordinate of blue color within the color area in order to increase the color temperature of the white color; and transforming the reference color such that the reference color is adjacent to the coordinate of red color within the color area in order to decrease the color temperature of the white color.

### BRIEF DESCRIPTION OF THE DRAWINGS

The above and/or other aspects of the present invention will become apparent and more readily appreciated from the following description of the exemplary embodiments, taken in conjunction with the accompanying drawings of which:

FIG. 1 is a control block diagram of a display apparatus according to an exemplary embodiment of the present invention;

FIG. 2A is a view illustrating a color space and a color area in three dimensions;

FIG. 2B is a view illustrating a section of a color space and a color area; and

FIG. 3 is a control flow chart of the display apparatus according to the exemplary embodiment of the present invention.

### DETAILED DESCRIPTION OF EXEMPLARY EMBODIMENTS OF THE INVENTION

Reference will now be made in detail to exemplary embodiments of the present invention, examples of which are illustrated in the accompanying drawings.

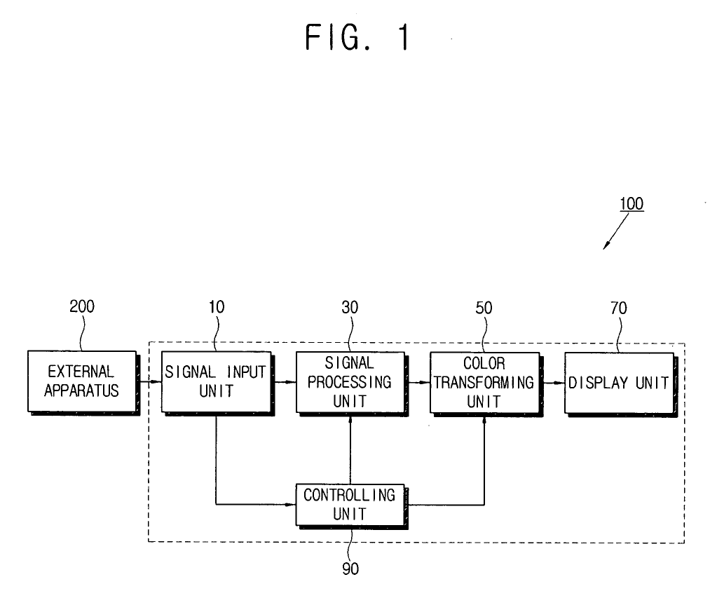

FIG. 1 is a control block diagram of a display apparatus according to an exemplary embodiment of the present invention.

As shown in FIG. 1, a display apparatus 100 according to the exemplary embodiment of the present invention includes a display unit 70 on which an image is displayed, a signal input unit 10, a signal processing unit 30, a color transforming unit 50 for transforming an image signal processed in the signal processing unit 30, and a controlling unit 90 for controlling these components.

The display unit 70 receives the image signal from the color transforming unit 50 and displays an image on a screen. The display unit 70 includes a display module (not shown) on which the image is displayed and a module driver (not shown) for processing the image signal input from the color transforming unit 50 to enable the image to be displayed on the display module. The display module may include various types of display modules such as a Cathode Ray Tube (CRT), a Digital Light Processing (DLP) projector, a Liquid Crystal Display (LCD), a Plasma Display Panel (PDP) and the like. In case where the display module is a DLP projector, the module driver includes an optical engine. In case where the display module is an LCD, the module driver includes a printed circuit board for converting the image signal input from the color transforming unit 50 into a data signal and a gate signal. Similarly, according to the type of display module, the display unit 70 may have a configuration corresponding to the module driver.

The signal input unit 10 receives an image signal and outputs the received image signal to the signal processing unit 30. It is to be understood that the signal input unit 10 may have different configurations according to the type of display module. For example, when the signal processing unit 30 processes a digital image signal, the signal input unit 10 may include an analog-to-digital (A/D) converter for converting an analog image signal into the digital image signal, and may further include separate components for supporting a Low Voltage Differential Signaling (LVDS) or Transition Minimized Differential Signaling (TMDS) interface for supporting input of the digital image signal. In addition, when the display apparatus 100 receives a TV broadcasting signal, the signal input unit 10 may include a tuner.

The signal input unit 10 may further include an input terminal through which an instruction signal is received from an external apparatus 200 to the controlling unit 90, which will be described later, and a pattern image having a pattern is received when white balance is adjusted. In this case, the pattern image may be an image on the basis of which it is determined whether the white balance is properly adjusted. For example, the pattern image may include a monochromatic image or a polychromatic image having a pattern. In this exemplary embodiment, the pattern image may be received from the external apparatus 200 or may be pre-stored in an internal memory (not shown) of the display apparatus 100. In addition, the image on the basis of which it is determined whether the white balance is properly adjusted may include an image signal received from a certain image signal source as well as the pattern image. In the following description, for the purpose of convenience of explanation, it is assumed that the pattern image having the pattern is included in an image according to an image signal.

The signal processing unit 30 converts the image signal input through the signal input unit 10 into an image signal which can be displayed by the display unit 70. The signal processing unit 30 may have different configurations according to the type of display module as mentioned above. For example, if the display module is an LCD, a PDP, or a DLP, the signal processing unit 30 may include a scaler (not shown) for scaling a digital image signal. If the display module is a CRT, the signal processing unit 30 may include an amplifying unit (not shown) for amplifying an image signal input through the signal input unit 10, vertical and horizontal deflecting units (not shown) for deflecting electron beams based on vertical and horizontal synchronization signals, etc. In addition, the signal processing unit 30 may further include a frame buffer (not shown) for temporarily storing an image signal input from the signal input unit 10 and then outputting the stored image signal to the scaler.

The controlling unit 90 controls the signal processing unit 30, the color transforming unit 50 and the signal input unit 10. In this exemplary embodiment, upon receiving an instruction signal to adjust white balance from the external apparatus 200 via the signal input unit 10 or receiving an instruction signal to adjust white balance according to a program pre-stored in the memory, the controlling unit 90 controls the color transforming unit 50 to perform color-transformation on the image signal output from the signal processing unit 30. In this case, the controlling unit 90 detects ambient illumination of the display apparatus 100 and can adjust the white balance based on a result of the detection or depending on conditions of setting of the display apparatus 100.

The color transforming unit 50 performs color-transformation on the image signal output from the signal processing unit 30 such that colors distributed in a white color area CA defined by a set of plurality of colors on a color space CS of colors displayed on the display unit 70 are color-transformed within the white color area CA. As used herein, the white color area CA refers to an area centered at an origin (center) of a section of the color space CS.

As used herein, the color space CS, which is employed for logical expression of colors, refers to a space in which all colors are indicated on a three-dimensional coordinate system. It is preferable but not necessary that the color space CS is a YCbCr color space in which brightness data are separated from hue data. In this exemplary embodiment, a CIELAB(L*a*b*) color space or CIELCH(L*C*h*) color space suggested by Commission International de Eclairage (CIE) may be employed as the color space CS. However, it is to be understood that different color spaces may also be employed as the color space CS without departing from the spirit of the present invention.

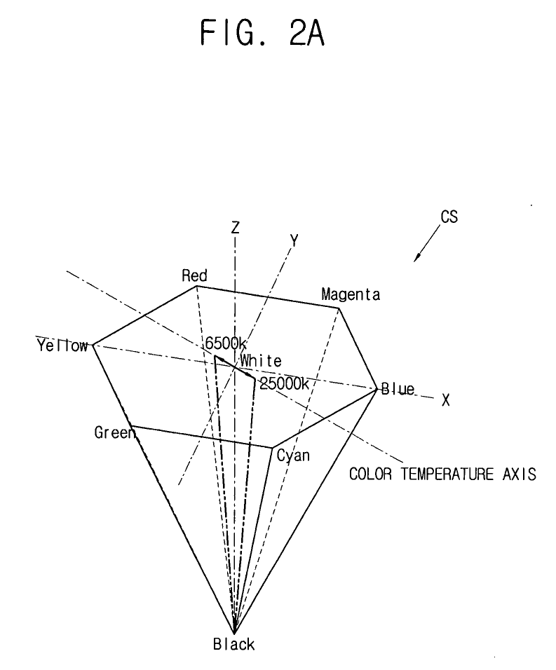

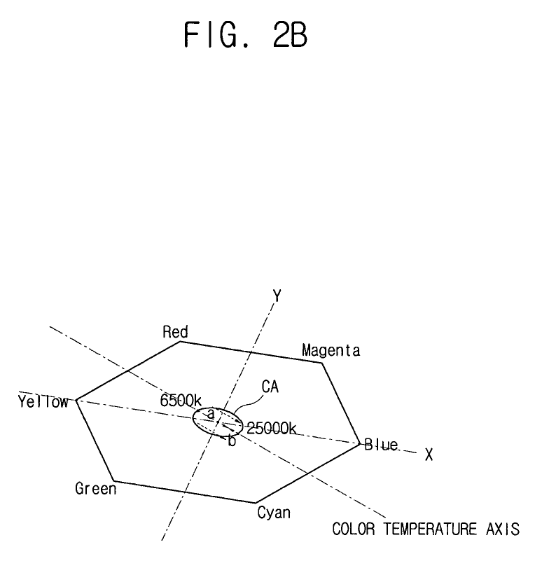

FIG. 2A shows a three-dimensional x-y-z coordinate system of a YCbCr color space CS defined according to a relationship among brightness, hue and saturation of colors. In this coordinate system, change of a phase means change of hue, change of a distance from an origin means change of saturation, and a change in a z-axis around the origin means change of brightness. In this exemplary embodiment, the color space CS is a six-axis color space defined by six primary colors: Red (R), Yellow (Y), Green (G), Cyan (C), Blue (B) and Magenta (M).

The color area CA is defined by a set of colors on the color space CS. In this case, the color transforming unit 50 recognizes a white color area according to a geometrical equation of the color area CA on the three-dimensional coordinate system. For example, if the color area CA has an elliptical shape, the color transforming unit 50 can recognize the white color area CA according to an elliptical equation.

In this exemplary embodiment, an example where the color area CA is parallel to an x-y plane, that is, brightness of color is not changed in color-transformation on the color area CA, will be described. In this case, the color transforming unit 50 performs color-transformation on a color difference signal, which expresses hue and saturation of color, included in the image signal output from the signal processing unit 30, thus changing the hue and/or saturation of color expressed by the color difference signal.

In this exemplary embodiment, the color area CA has an elliptical shape as an example, as shown in FIG. 2B. In this case, it is preferable but not necessary that the elliptical shape has a color temperature axis, which is a basis of change of color temperature, as a major axis. In this case, particularly the white color area CA makes an acute angle with each of coordinates corresponding to red and blue colors. Accordingly, the color temperature increases as it gets close to a coordinate adjacent to the blue color, i.e., 25000K, while the color temperature decreases as it gets close to a coordinate adjacent to the red color, i.e., 6500K. In other words, the color transforming unit 50 can change the color temperature by performing color-transformation on values of color difference signals Cb and Cr under control of the controlling unit 90. Specifically, the color temperature increases as a value of Cb having information on the blue color increases, while the color temperature decreases as a value of Cr having information on the red color increases.

The image signal input from the signal processing unit 30 is separated into a brightness signal and a color difference signal. Then, the color transforming unit 50 transforms a coordinate of color corresponding to the color difference signal into a coordinate according to control of the controlling unit 90. In this case, the color transforming unit 50 color-transforms a coordinate (x, y) (point a in FIG. 2B) into a coordinate (x′, y′) (point b in FIG. 2B).

The coordinate (x′, y′) can be obtained according to the following equation:

$$( \begin{matrix}{x}^{′} \\ {y}^{′}\end{matrix} ) = ( \begin{matrix}Gx \times x \\ Gy \times y\end{matrix} ) + ( \begin{matrix}Ox \\ Oy\end{matrix} )$$

where Gx is a gain value of x, Gy is a gain value of y, Ox is an offset value of x, and Oy is an offset value of y.

In this exemplary embodiment, it is preferable but not necessary that, if the image signal displayed on the display unit 70 has a low gray scale, the coordinate (x′, y′) is determined by the offset values, and, if the image signal displayed on the display unit 70 has a high gray scale, the coordinate (x′, y′) is determined by the gain values.

The color transforming unit 50 may set a color within the white color area CA to be a reference color and determine a degree of color-transformation of other colors within the color area CA based on a degree of color-transformation of the reference color. In other words, when the reference color within the elliptical color area is transformed according to a control signal from the controlling unit 90, other colors within the color area CA, except the reference color, are transformed at a ratio. In this case, the degree of color-transformation depends on a shape of the color area.

In addition, when the white balance of the image signal is adjusted according to a control signal from the controlling unit 90, the color transforming unit 50 can transform the reference color such that the reference color is adjacent to the coordinate of blue color within the color area CA in order to increase the color temperature of the white color. Moreover, the color transforming unit 50 can transform the reference color such that the reference color is adjacent to the coordinate of red color within the color area CA in order to decrease the color temperature of the white color.

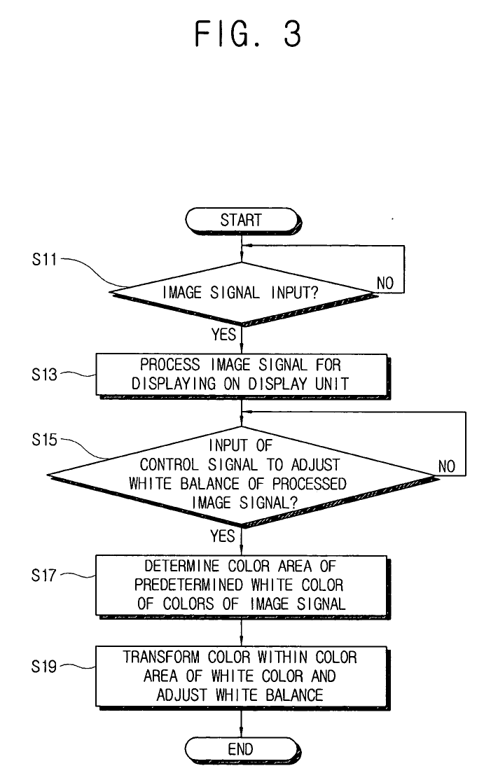

FIG. 3 is a control flow chart of the display apparatus 100 according to the exemplary embodiment of the present invention.

Referring to FIG. 3, the display apparatus 100 receives an image signal through the signal input unit 10 at operation S11. This image signal includes a pattern image output from a pattern output apparatus as well as an image signal output from an image source such as a broadcasting station, a DVD, a VCR and so on. Next, the signal processing unit 30 processes the image signal input through the signal input unit 10 such that the image signal can be displayed on the display unit 70 at operation S13, and output the processed image signal to the color transforming unit 50.

Next, upon receiving a control signal to adjust white balance of the image signal from the controlling unit 90 at operation S15, the color transforming unit 50 adjusts the white balance by performing color-transformation on a color within a white color area CA of the image signal at operation S19. Specifically, according to a control signal from the controlling unit 90, the color transforming unit 50 determines the white color area CA at operation S17, distinguishes between a color within the determined color area CA and other colors, and adjusts the white balance of the image signal by performing color-transformation on only the color within the white color area CA at operation S19.

As described above, when the white balance of the image signal is adjusted, the display apparatus 100 adjusts only the color within the white color area CA. That is, the display apparatus 100 of the present invention adjusts only the color within the color area CA without adjusting other colors, while the conventional display apparatus changes all colors displayed on the display unit 70 when the white balance is adjusted. Accordingly, colors displayed on the display unit 70 can be prevented from being changed as a whole regardless of users' intentions.

As discussed above, the exemplary embodiments of the present invention provides a display apparatus, which is capable of adjusting white balance of an image signal by changing only white color distributed in a color area, and a control method thereof.

Although a few exemplary embodiments of the present invention have been shown and described, it will be appreciated by those skilled in the art that changes may be made in these exemplary embodiments without departing from the principles and spirit of the invention, the scope of which is defined in the appended claims and their equivalents.

What is claimed is:

1. A display apparatus comprising:
a display unit;
a signal processing unit which processes an image signal to be displayed on the display unit;
a color transforming unit which adjusts a white balance of the image signal within a color area defined by a set of adjacent colors in a color space; and
a controlling unit which controls the color transforming unit to perform color-transformation on only a white color within the color area of colors of the image signal in order to adjust the white balance of the image signal.

2. The display apparatus according to claim 1, wherein the color transforming unit sets a color within the color area to be a reference color, and determines a degree of color-transformation of other colors within the color area based on a degree of color-transformation of the reference color.

3. The display apparatus according to claim 2, wherein the color space is a YCbCr color space.

4. The display apparatus according to claim 3, wherein the color area has an elliptical shape making an acute angle with coordinates of red and blue colors, with a color temperature axis as a major axis on the YCbCr color space.

5. The display apparatus according to claim 4, wherein, if the white balance of the image signal is adjusted, the controlling unit transforms the reference color so that the reference color is adjacent to the coordinate of blue color within the color area to increase the color temperature of the white color, and transforms the reference color so that the reference color is adjacent to the coordinate of red color within the color area to decrease the color temperature of the white color.

6. The display apparatus according to claim 5, wherein the controlling unit receives a control signal to adjust the color temperature of the white color from an external apparatus and controls the color transforming unit to adjust the white balance according to the control signal.

7. The display apparatus according to claim 6, wherein the controlling unit causes a pattern image to be displayed on the display unit and determines an adjustment condition of the white balance of the image signal adjusted in the color transforming unit according to a change of the pattern image.

8. A control method of a display apparatus, the method comprising:
processing an image signal to be displayed on a display unit of the display apparatus; and
adjusting a white balance of the processed image signal by adjusting a white color of the processed image signal within a color area defined by a set of adjacent colors in a color space.

9. The control method according to claim 8, wherein the adjusting the white balance comprises:
setting a color within the color area to be a reference color;
determining a degree of color-transformation of other colors within the color area based on a degree of color-transformation of the reference color; and
color-transforming a color within the color area depending on the determined degree of color-transformation.

10. The control method according to claim 9, wherein the color space is a YCbCr color space.

11. The control method according to claim 10, wherein the color area has an elliptical shape making an acute angle with coordinates of red and blue colors, with a color temperature axis as a major axis on the YCbCr color space.

12. The control method according to claim 10, wherein the adjusting the white balance comprises:
transforming the reference color so that the reference color is adjacent to the coordinate of blue color within the color area to increase the color temperature of the white color; and
transforming the reference color so that the reference color is adjacent to the coordinate of red color within the color area to decrease the color temperature of the white color.

13. The control method according to claim 12, further comprising receiving a control signal to adjust the color temperature of the white color from an external apparatus, wherein the white balance is adjusted the according to the control signal.

14. The control method according to claim 13, further comprising displaying a pattern image on the display unit and determining an adjustment condition of the white balance of the image signal adjusted in the color transforming unit according to a change of the pattern image.
